(19) United States
(12) Patent Application Publication
(10) Pub. No.: US 2008/0116105 A1
(43) Pub. Date: May 22, 2008

(54) Storage container and method of making the same

(76) Inventor: Michael Statham, Marietta, GA (US)

Correspondence Address: MCGUIREWOODS, LLP, 1750 TYSONS BLVD, SUITE 1800, MCLEAN, VA, 22102, US

(21) Appl. No.: 11/798,130

(22) Filed: May 10, 2007

Related U.S. Application Data
(60) Provisional application No. 60/799,231, filed on May 10, 2006.

(51) Int. Cl. A61J 1/03; B65D 85/00; B65D 1/00; B65D 25/00; B44C 1/22

(52) U.S. Cl. 206/534; 206/459.5; 29/592; 216/10

(57) ABSTRACT

An aspect of the present invention comprises a unique method of manufacturing and tracking storage vial, tubes, trays, and other containers used in the life and clinical science industries, through the use of 2d, linear, binary, or other alphanumeric information etched into the storage containers. Another aspect of the present invention is a storage container having identifying information etched thereon with a laser. Yet another aspect of the present invention comprises an in-house etching station for a biological or chemical manufacturer/supply company, for creating customer specified identifiers on the storage containers.

### CROSS REFERENCE TO RELATED APPLICATIONS

This application claims priority under 35 U.S.C. § 119(e) to U.S. Provisional Application Ser. No. 60/799,231, filed on May 10, 2006, the disclosure of which is expressly incorporated by reference herein in its entirety.

### BACKGROUND

1. Field of the Invention

The invention relates generally to methods and systems for marking and tracking storage containers, more specifically the present invention relates to methods and systems of uniquely marking storage vials, tubes, and trays used in the life, pharmaceutical, diagnostic and clinical science industries for identification and tracking.

2. Background of the Invention

Storage vials, tubes, and trays made of various plastics are frequently used in the life and clinical sciences to store, preserve, and categorize the various chemicals, compounds, samples, and/or other materials which they contain. Currently within the industry such storage containers are manufactured through a process known as either injection molding or injection blow molding. This allows for the accurate, reliable, fast and clean manufacturing of plastic parts. These manufacturing techniques allow the products produced to be either clean room produced in order to ensure that there is no contamination to the end user's sample and/or will allow for the parts to be sterilized through some type of ultraviolet (UV) light or radiation.

In order to properly identify and track the materials stored in the containers, it is known in the art to label the storage containers. One such method of labeling is bar-coding. Although bar-coding is not new to the industry, its use has been limited due to the current practices used in creating the storage tubes, vials, or trays, and the manufacturing process associated with the application of the bar-code to each tube. It has been typically done through either insert molding, two-piece molding, or layering, which may include using different materials. These methods create a code after the initial manufacturing of the storage container and require multiple steps in order to create a surface for the bar-code, and thus increase the cost of each container. The containers are also limited as to where the bar-codes can be placed and it is cost prohibitive to add multiple bar-codes to a single container. For example once a certain area of the container is designated to have a bar-code, major changes must be made to the molding equipment and the manufacturing process must be altered in order to create a new bar-code.

Within the life and clinical science industry, there are also manufacturers who specialize in the manufacturing and distribution of various chemicals or reagents. Examples of such reagents include oligos, primers, Dntps, buffers, salts, solvents and various synthesized compounds. The focus of these companies is to provide the aforementioned samples to a wide group of researchers within the industry upon short notice. Once requested from a scientist or company, there is a need for specified labeling on the storage tubes or containers to identify the chemicals contained therein. Such companies generally use a generic code generated by the manufacturer of the container to identify the chemicals, and as a result, there is a limited number of containers in which they can supply their goods with a secure label or etching. If a customer requires a specific code or label, then an order must be placed with a plastics manufacturer to generate the specific code, which normally takes at least 8-12 weeks. Since most orders for chemicals or reagents are placed with required delivery within 48 hours, the ability to wait on custom coded containers, aside from an adhesive label, is not an option.

What is needed then, is a method of manufacturing such storage vials, tubes, trays, or other containers that allows the opportunity to quickly and economically mark the storage containers directly without having to result to the costly application of other products to the containers after the initial molding process.

### SUMMARY OF THE INVENTION

The invention avoids the disadvantages and drawbacks of the prior art and/or satisfies the need to provide a unique method of manufacturing and tracking such storage vial, tubes, trays and other containers through the use of two-dimensional, linear, binary, or other alphanumeric information etched into the storage containers.

Accordingly, an aspect of the present invention is a method of manufacturing storage containers that may be etched with identifying information.

Another aspect of the present invention is a storage container having identifying information etched thereon with a laser.

Another aspect of the present invention is an insert that is etched with the identifying information and then attached to the storage container.

Accordingly, the invention provides a method of manufacturing a storage container or reaction vessel, where the method includes the steps of liquefying a polymer material, mixing a compound with the polymer material to form a mixture, forming at least one storage container from the mixture and etching an identification indicia directly on the at least one storage container, where the compound has properties that allow the at least one container to be etched directly without further treatment of the at least one container. The compound may be one of a metal oxide based additive and an organic based additive. The let down ratio of the compound may be in the range of about 0.01 percent to about 25 percent, or may be in the range of about 0.1 percent to about 25 percent. The etching may be performed by a laser. The method may further include the step of mixing an additive with the polymer to provide color to the storage container. The identification indicia may include at least one alpha-numeric character or a barcode. The container may be configured to be used in the life sciences, pharmaceutical, diagnostic and clinical industries. The polymer may be selected from the group consisting of polypropylene, polystyrene, polyethylene, and COC. The step of forming may include one of injection molding and injection blow molding. The method may also include the steps of forming at least one insert from the mixture, etching an identification indicia directly on the at least one insert and attaching the at least one insert to the at least one storage container.

Another aspect of the invention provides a storage container for use in storing materials used in the life sciences, pharmaceutical or clinical field. The storage container includes a container comprising a polymer material and an additive compound, where the additive compound has properties that allow the at least one container to be etched without further treatment, and an identification indicia etched onto the container. The may be one of a metal oxide based additive and an organic based additive. The etching may be performed by a laser. The storage container may also include a second additive to provide color to the storage container. The identification indicia may include at least one alpha-numeric character or a barcode. The polymer may be selected from the group consisting of polypropylene, polystyrene, polyethylene, and COC. The storage container may be form via one of injection molding and injection blow molding.

Additional features, advantages and embodiments of the invention may be set forth or apparent from consideration of the following detailed description, drawings and claims. Moreover, it is to be understood that both the foregoing summary of the invention and the following detailed description are exemplary and intended to provide further explanation without limiting the scope of the invention as claimed.

### BRIEF DESCRIPTION OF DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention. In the drawings:

FIG. 1 is a flow chart illustrating a process for making storage containers according to the principles of the invention;

FIG. 2 is side view of an embodiment of a storage container constructed according to the principles of the invention;

FIG. 3 is a bottom view of an embodiment of a storage container constructed according to the principles of the invention;

FIGS. 4A, 4B, 4C and 4D illustrate different views of a storage container constructed according to the principles of the invention; and

FIGS. 5A, 5B, 5C and 5D illustrate different views of another storage container and insert constructed according to the principles of the invention.

### DETAILED DESCRIPTION

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numbers represent similar parts throughout several views of the drawings.

The storage containers of the present invention are typically the type used in the life and clinical sciences for storage of compounds in pharmaceutical, and other clinical or diagnostic research. Such storage containers include, but are not limited to, tubes, vials, dishes, trays, and other like storage mediums. These vials and trays are often used for the replication, solubilization, analization, and storage of potential drug compounds, reagents, DNA samples, tissue samples, blood samples and chemicals used throughout these industries. There are many different sizes in which such samples are stored, transported, replicated and mixed within the industries but the average size is between 10 ml and 50 ml. The trays typically range from 1 tube or well, all the way, but not limited to, up to 3456 wells which most adhere to an industry standard known as SBS standards.

Accordingly, an aspect of the present invention comprises tracking such storage vial, tubes, trays and other containers through the use of 2d data matrix, linear, binary, or other alphanumeric information etched into the storage containers themselves. This technology may allow for etching during the actual manufacture of the storage containers, or for on demand etching of 2d, linear, binary, or alphanumeric labeling creating specific codes to be applied, at the customers request within a few hours or days.

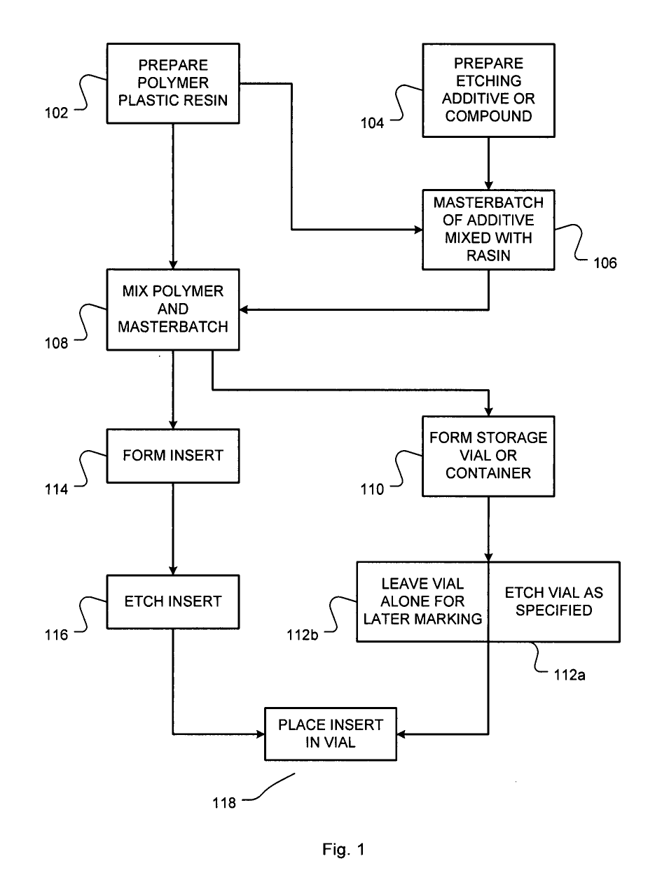

FIG. 1 is a flow chart illustrating a process for making storage containers according to the principles of the invention. Materials used for making the containers are mixed at step 102. A compound or additive to permit laser etching of the containers is prepared at step 104. The additive and a portion of the material mixture is combined into a masterbatch at step 106. The masterbatch is added back into the mixture of materials at step 108. The containers are formed from the masterbatch material at step 110. At step 112a, the containers are etched as specified. Alternative, at step 112b, the vial is left alone for later marking. An insert is formed from the masterbatch material at step 114. At step 116, the insert is etched, and the insert is attached to the vial at step 118. The process illustrated in FIG. 1 will now be described in greater detail below.

Materials used for making the containers are mixed at step 102. The storage containers may be typically made out of different types of main polymers with a multitude of co-polymers added at different times. Appropriate polymers and methods of making appropriate storage containers for the life and clinical science industries are well known to those skilled in the art. Accordingly, the laser etching process of the present invention may be used on various types of polypropylene, polystyrene, polyethylene, COC, other polymers known in the art, or combinations thereof, or any derivation of the foregoing polymers. The storage container sizes may typically fall within the ranges provided described above, but may also be custom manufactured to other specifications of size and/or shape.

Accordingly, an aspect of the present invention comprises the manufacture of storage containers that allows the subsequent etching of the resulting container. These containers are typically made of, but not limited to, PP (polypropylene), PS (polystyrene), PE (Polyethylene), PET, COC, or a blend of these polymers. Such containers may also be made of other polymers, copolymers, and combinations thereof, that are well known in the art.

A compound to permit laser etching of the containers may be prepared at step 104. The compound or additive may be prepared by adding to these materials which allow the resulting storage container to be laser etched after it is manufactured. Suitable additives may include sulfates, metal oxides such as aluminum oxide, organic compounds, or other similar additives. One such suitable additive having these characteristics may be obtained from Chroma Corporation of McHenry, Ill. under the name of Chroma Lazer-Tec®. Another suitable additive is Maxithen® which may be obtained from the Gabriel-Chemie company.

An aspect of the present invention comprises mixing the additive with at least one of the aforementioned polymers to form a masterbatch at step 106. The polymer for the masterbatch may be obtained from the mixture of step 102. Generally, the polymers are in pellet form, but may also be mixed in other appropriate forms known in the art such as liquid. Processes for inserting the additive to the carrier system my include, but are not limited to, Liquid Color Pump, Liquid Concentrate, Luminescent Pigments, or other methods that are known in the art. Let down ratios, or use rates, are determined after evaluating the amount of additive pigment, dyes or additives required to achieve the desired color in the final part giving effect to their incorporation into a concentrated product. According to an embodiment of the invention, the let down ration for the masterbatch may be in the range of about 0.01% to about 30%, and more specifically between about 1% and about 25%. Other ranges may also be used.

At step 108, some or all of the masterbatch is combined with the original batch. Once the amount of compound or additive is determined, it should remain constant in the carrier system (pellet or liquid). As use rates decrease, the “loading” of the required amount of dry pigment dyes or additives may increase. Establishing let down ratios may take into consideration the ability of the molder or fabricator to ultimately produce an acceptable product on the machine having the least mechanical ability to homogenize the melt stream. The let down ratio of the additive in the masterbatch and original batch mixture can be about 0.01% to about 25%, more specifically from about 0.1% to about 10%, and even more specifically about 1% to about 5%. Other ranges may also be used.

The containers are formed at step 110. These containers may be formed using processes that are known in the art. According to an embodiment of the invention, after the manufacturing of the container there may be no need to apply any other coatings to the container in order for the laser to mark any surface of the container. Accordingly, any surface that has been requested to be marked, or that is desirable to mark, may easily be etched using a laser. The storage containers are typically manufactured using injection molding and/or injection blow molding techniques that are well known in the art, and the resulting container may subsequently be etched and used for the various vials, tubes, trays, plates, dishes, and other storage vessels used for the storage, transport, replication, solubilization, or other use of samples used in the life science & clinical science industries. It should be noted, however, that the present invention is not limited to these industries and is applicable to any plastic storage containers where it is desirable to easily mark and track the container.

As noted above, the resulting mixture of polymer and additive may then inserted into an injection molding apparatus that has been set up to mold the desired container. The addition of the compound may allow the resulting container to easily be etched. Further, this process may not greatly degrade, either visually, chemically or physically the resulting storage container or its makeup. The additive/compound may be either in a concentrated or non-concentrated format before being inserted into the injection molding apparatus. The resulting storage containers may then be easily marked directly after coming off the injection molding equipment. The marking may be a generic mark or a mark that can be customer or manufacturer specified. This allows each product to be uniquely identified and quickly put into lots. As a result, manufacturing time for future reference after sale, or use in laboratory practices, are decreased making product defect and recalls more effective and cost efficient. If the resulting storage containers are not marked immediately upon being manufactured they may be stored for future use and marking by either the manufacturer or a customer of the manufacturer.

At step 112, the containers are etched. Once the storage containers have been manufactured, they may be etched at some point with a laser. Due to the trend towards 2d or Data matrix coding, the laser may be precise in both temperature and beam. Proper laser usage may occur to avoid burning or pitting the plastic storage container leaving marks that can not be read by typically barcode scanners or even by visual reading. Appropriate lasers include, but are not limited to, YAG or C02 diode pumped solid or fiber state high beam quality lasers with about 10 watts of power or more.

A further aspect of the present invention includes the use of a visual laser marking system, or laser CAD software, as well as a bar-coding software, that are capable of providing each container with its own unique identification indicia never to be duplicated except upon customer request. Proper wattage and peak power may allow for short marking time, high contrast, and low penetration depths even with very small marks. The system may be driven by single or multiple computers, such as PC's, Macs' or the like, depending upon the needs of the manufacturer or customer. Such laser systems are commercially available and can be obtained by a variety of manufacturers.

An embodiment of an etching system for etching the storage containers of the present invention may include, but is not limited to the following description. Storage containers may be loaded by either an automated apparatus or manually into a vibratory feeder or some other sorting and placing system, and then onto a conveyor belt or other handler for loading into the area where the containers may be marked by the laser. The storage containers will be etched, in a designated location with either a 2d, linear, binary, or alphanumeric code. The etching location may be designated by the customer or manufacturer, or may even be random. Etching time for a single container is typically between 0.01 seconds to 10 seconds depending on the desired mark.

In addition, at step 114, inserts are formed. An insert may be formed using the techniques as described above with respect to forming the storage containers. At step 116, inserts are etched. An insert may be etched using the techniques as described above with respect to forming the storage containers. At step 118, an insert is attached to a storage container.

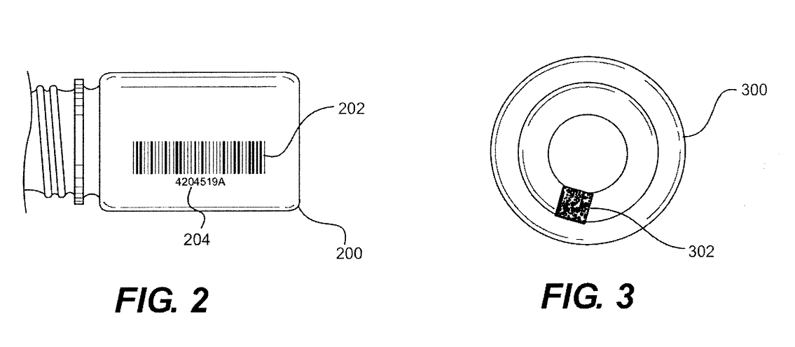

Exemplary embodiments of the storage containers of the present invention are shown in FIGS. 2 and 3. A side view of an embodiment of the storage containers of the present invention is shown in FIG. 2. The container 200 has a bar code 202 and text 204 etched thereon. Total etching time for the embodiment shown in FIG. 1 was 1.35 seconds. Other etching times may be used and are within the scope of the invention.

A bottom view of another embodiment of the storage containers of the present invention is shown in FIG. 3. A 2d code 302 is etched on the bottom of the container 300. Total etching time for the embodiment shown in FIG. 2 was 0.39 seconds.

The etched containers may then be moved from the etching area via manual manipulation or some automated format known in the art. The resulting etched containers may then be stored, bagged, or packaged according to specifications. The storage containers may then be shipped to a customer specified location.

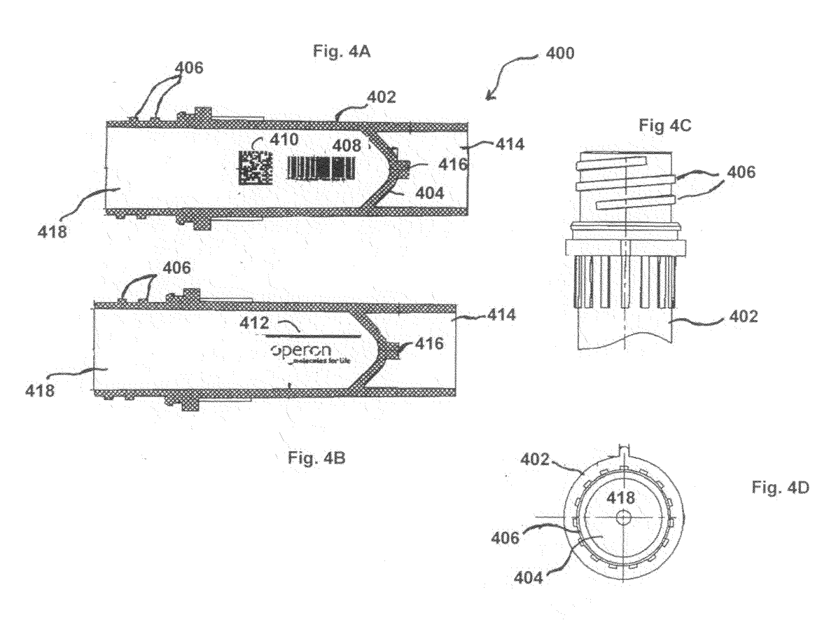

FIGS. 4A, 4B, 4C and 4D illustrate different views of a storage container constructed according to the principles of the invention. As shown, a storage container 400 includes side 402 with a bottom portion 404 with a protrusion 516 that extends into a bottom opening 414. The storage container 400 also includes a top opening 418 that allows storage of materials within the storage container. The side 402 includes threads 406 near the top opening 418 to permit a cap (not shown) to be attached to the storage container 400 to secure any material within it.

The storage container 400 has etched thereon a barcode 408 and a 2d 410 on one side of the storage container, as illustrated in FIG. 4A. The barcode 408 and 2d 410, or other information that could be etched on the storage container 400, may be used to track information about the contents, the processing undergone, and the like. On the other side of the storage container 400, as shown in FIG. 4B, a name or logo 412 is etched thereon. This information may be custom specified by a customer to allow easy identification.

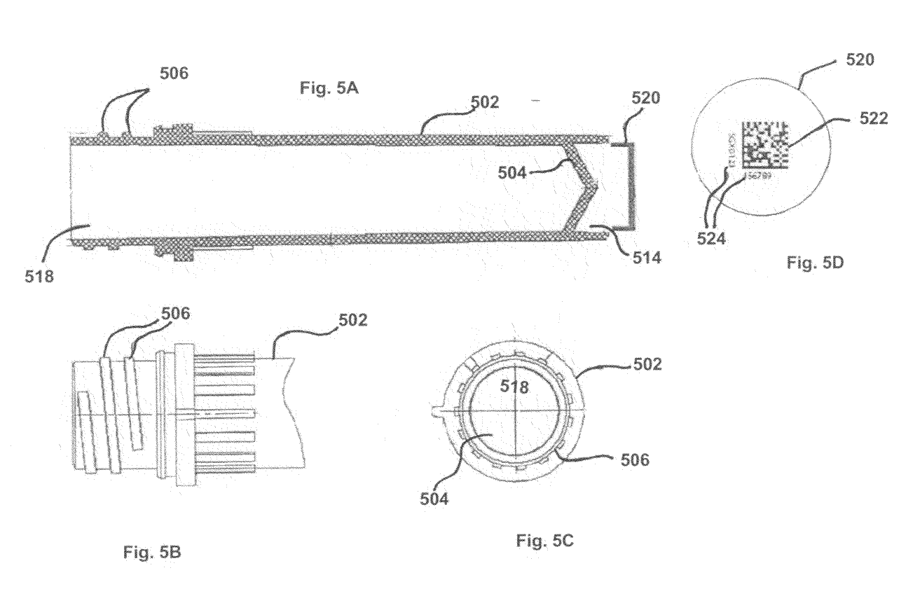

FIGS. 5A, 5B, 5C and 5D illustrate different views of another storage container and insert constructed according to the principles of the invention. As shown, a storage container 500 includes side 502 with a bottom portion 504 that extends into a bottom opening 514. The storage container 500 also includes a top opening 518 that allows storage of materials within the storage container. The side 502 includes threads 606 near the top opening 518 to permit a cap (not shown) to be attached to the storage container 600 to secure any material within it.

FIG. 5A shows an insert 520 that is attached to the storage container 500 at the bottom opening 514. According to an embodiment of the invention, the insert 520 may be attached to the storage container 500 using any type of method, including adhesive, clips, fasteners, or the like. The insert 520 has etched thereon a 2d 522 as well as alpha-numeric identifiers 524, as illustrated in FIG. 5D. Moreover, while the storage container 500 has been shown with a sloped bottom portion, it is understood that the storage container 500 may be manufactured to have a flat bottom which in turn may be etched with information. In such an embodiment, it may not be necessary to have an insert 520 attached to the storage container 500. However, such an insert 520 could be attached to a flat bottom of storage container 520.

The present invention allows the storage container to be marked on any area of the part and may also have multiple markings for different types of scanners or customer specified parameters. Accordingly, an aspect of the present invention comprises the creation of specific data sequences on the storage containers. Such data sequences can be created from either a custom manufactured piece, or an in-stock item, to a customer's specifications within minutes of process on the laser. Such products may then be quickly shipped to the customer, if needed. As such, a customer may choose any storage container having a single unique identifier, or even multiple identifiers, on the storage container.

Another aspect of the present invention comprises an in-house etching station for a biological or chemical manufacturer/supply company, for creating customer specified identifiers on the storage containers. The storage containers may be available as stock items, thus allowing the manufacturer of the biological reagents or chemicals to uniquely identify the parts for their customers, without relying on generically generated parts by a storage container manufacturer, and would eliminate additional lag time for custom made storage containers. Both the manufacturer of the reagents and their customer would benefit from the wide variety of storage containers that would now be available to mark, and provide more options for laboratory practice. The customers would no longer be required to adapt to the manufacturer's limited products and would be able to choose the most suitable storage containers for their needs. The in-house etching station may be purchased or leased, including the appropriate storage containers having the proper resin blend and additive to suit their particular needs.

While the invention has been described in terms of exemplary embodiments, those skilled in the art will recognize that the invention can be practiced with modifications in the spirit and scope of the appended claims. These examples given above are merely illustrative and are not meant to be an exhaustive list of all possible designs, embodiments, applications or modifications of the invention.

What is claimed is:

1. The method of manufacturing a storage container or reaction vessel, said method comprising the steps of:
liquefying a polymer material;
mixing a compound with the polymer material to form a mixture;
forming at least one storage container from the mixture; and
etching an identification indicia directly on the at least one storage container; and
wherein the compound has properties that allow the at least one container to be etched directly without further treatment of the at least one container.

2. The method of claim 1, wherein the compound is one of a metal oxide based additive and an organic based additive.

3. The method of claim 1, wherein the let down ratio of the compound is in the range of about 0.01 percent to about 25 percent.

4. The method of claim 1, wherein the let down ratio of the compound is in the range of about 0.1 percent to about 25 percent.

5. The method of claim 1, wherein the etching is performed by a laser.

6. The method of claim 1, further comprising the step of mixing an additive with the polymer to provide color to the storage container.

7. The method of claim 1, wherein the identification indicia includes at least one alpha-numeric character.

8. The method of claim 1, wherein the identification indicia is a barcode.

9. The method of claim 1, wherein the container is configured to be used in the life sciences, pharmaceutical, diagnostic and clinical industries.

10. The method of claim 1, wherein the polymer is selected from the group consisting of polypropylene, polystyrene, polyethylene, and COC.

11. The method of claim 1, wherein said step of forming comprises one of injection molding and injection blow molding.

12. The method of claim 1, further comprising the steps of:
forming at least one insert from the mixture;
etching an identification indicia directly on the at least one insert; and
attaching the at least one insert to the at least one storage container.

13. A storage container for use in storing materials used in the life sciences, pharmaceutical or clinical field, said storage container comprising:
a container comprising a polymer material and an additive compound, said additive compound having properties that allow the at least one container to be etched without further treatment; and
an identification indicia etched onto said container.

14. The storage container of claim 13, wherein the additive is one of a metal oxide based additive and an organic based additive.

15. The storage container of claim 13, wherein the etching is performed by a laser.

16. The storage container of claim 13, wherein the container further comprises a second additive to provide color to the storage container.

17. The storage container of claim 13, wherein the identification indicia includes at least one alpha-numeric character.

18. The storage container of claim 13, wherein the identification indicia is a barcode.

19. The storage container of claim 13, wherein the polymer is selected from the group consisting of polypropylene, polystyrene, polyethylene, and COC.

20. The storage container of claim 13, wherein the container is made via one of injection molding and injection blow molding.
